(19) United States
(12) Patent Application Publication
(10) Pub. No.: US 2009/0191976 A1
(43) Pub. Date: Jul. 30, 2009

(54) METHOD OF ASSEMBLING CAPTIVE SCREW

(75) Inventors: Ting-Jui Wang, Sindian City (TW); Ming-De Wu, Sindian City (TW)

Correspondence Address: SCHMEISER, OLSEN & WATTS, 22 CENTURY HILL DRIVE, SUITE 302, LATHAM, NY, 12110, US

(73) Assignee: FIVETECH TECHNOLOGY INC., Sindian City (TW)

(21) Appl. No.: 12/022,203

(22) Filed: Jan. 30, 2008

(51) Int. Cl. B23P 11/00; B21J 5/00

(52) U.S. Cl. 470/2

(57) ABSTRACT

A method for assembling captive screw includes the steps of providing an annular base and positioning an annular washer on a top of the annular base; providing a screw, a coil spring, and a sleeve; downward passing the screw through the coil spring and a top opening of the sleeve; and threading a threaded section of the screw through the annular washer, so that the annular washer is fitted around a shank of the screw to locate below the top opening of the sleeve and above the threaded section of the screw. An inner circumferential edge of the annular washer is not worn away by the threaded section of the screw threaded therethrough, enabling the annular washer to keep a small inner diameter for tightly fitting around the shank of the screw and ensuring reliable assembling of the sleeve to the screw.

### FIELD OF THE INVENTION

The present invention relates to a method of assembling a captive screw, and more particularly to a captive screw assembling method, in which a screw of the captive screw is passed through an annular washer by threading a threaded section of the screw through the annular washer instead of downward pressing the threaded section through the annular washer.

### BACKGROUND OF THE INVENTION

FIGS. 1 and 2 are exploded perspective view and assembled sectional view, respectively, of a captive screw 1. As shown, the captive screw 1 includes a screw 11, a coil spring 12, a sleeve 13, and an annular washer 14. The screw 11 includes, from top to bottom, a head 111, a shank 112, and a threaded section 113. The sleeve 13 is provided at a top thereof with a diametrically reduced through opening 131, and around a lower outer surface with a radially outward extended stop flange 132. When the captive screw 1 is fully assembled, the annular washer 14 is fitted around and restricted to a section of the shank 112 below the through opening 131 and above the threaded section 113. With the annular washer 14, the sleeve 13 is movably assembled to the screw 11. The coil spring 12 is mounted around the shank 112 of the screw 11 with two ends respectively pressed against the head 111 and the stop flange 132. The above-structured captive screw 1 is widely employed in the connection of two planks in thickness direction, for example.

FIGS. 3 to 5 show a conventional method of assembling a captive screw, and FIG. 6 is an enlarged view of the circled area in FIG. 5. As shown, in the conventional method of assembling a captive screw, an annular base 17 is provided. The annular base 17 is internally movably provided with an annular cutter 18. A washer material 16 having at least one through opening 161 is positioned on a top of the annular base 17, and a sleeve 15 for the captive screw is positioned on a top of the washer material 16. Then, the screw 11 is positioned in the sleeve 15, and the coil spring 12 is mounted around the shank 112 of the screw 11 with two ends respectively pressed against the head 111 of the screw 11 and an annular shoulder portion 153 inside the sleeve 15. A push tool 2 is used to push the screw 11 at the head 111, so that the threaded section 113 of the screw 11 is forced to pass through the through opening 161 of the washer material 16. Thereafter, the annular cutter 18 in the annular base 17 is caused to move upward, so as to produce an annular washer 14 from the washer material 16, and the annular washer 14 is fitted around the shank 112 of the screw 11 to locate above the threaded section 113 and below the shoulder portion 153. With the annular washer 14, the sleeve 15 is movably assembled to the screw 11.

In the above-described conventional captive screw assembling method, since the threaded section 113 of the screw 11 is pressed through an inner circumferential edge of the through opening 161 of the washer material 16 before the annular cutter 18 is moved upward to produce the annular washer 14, the annular washer 14 so produced has an inner circumferential edge that is worn away by the threaded section 113 to thereby have an increased inner diameter. As a result, the inner circumferential edge of the annular washer 14 provides a weak supporting force against an upper end of the threaded section 113, and the sleeve 15 movably assembled to the screw 11 tends to loosen from the threaded section 113 of the screw 11.

One of the conventional ways to compensate the increased inner diameter of the worn inner circumferential edge of the annular washer 14 is to increase an overall size of the annular washer 14 in advance. However, the captive screw 1 would have an overall size increased along with the size-increased annular washer 14, and could not be reduced in volume. Moreover, the above-described conventional method of assembling a captive screw requires the use of assembling tools with complicate structure, such as the push tool 2, the annular base 17, and the annular cutter 18, to thereby increase the manufacturing cost of the captive screw.

It is therefore desirable to develop an improved method of assembling captive screw that could be performed with the help of a relatively simple tool to reduce the manufacturing cost of the captive screw, and allows the annular washer of the captive screw to keep a small inner diameter for tightly fitting around the shank of the screw and ensuring strong and reliable assembling of the sleeve to the screw. And, with the small inner diameter, the annular washer and accordingly, the whole captive screw, may have a reduced overall volume.

### SUMMARY OF THE INVENTION

A primary object of the present invention is to provide a method of assembling captive screw that could be performed with the help of a relatively simple tool to reduce the manufacturing cost of the captive screw.

Another object of the present invention is to provide a method of assembling captive screw that does not cause wearing of the inner circumferential edge of the annular washer of the captive screw to thereby allow the annular washer to have a small inner diameter for tightly fitting around the shank of the screw and ensuring strong and reliable assembling of the sleeve to the screw.

A further object of the present invention is to provide a method of assembling captive screw that allows the whole captive screw to have a reduced overall volume.

To achieve the above and other objects, the method of assembling captive screw according to the present invention includes the following steps:
(1) provide an annular base and position an annular washer on a top of the annular base;
(2) provide a screw, a coil spring, and a sleeve; wherein the screw includes from top to bottom a head, a shank, and a threaded section, and the sleeve is provided on a top with a diametrically reduced through opening;
(3) downward passed the threaded section of the screw through the coil spring and the through opening on the sleeve, so that two ends of the coil spring are respectively pressed against the head of the screw and a predetermined position on the sleeve; and
(4) cause helical screw threads on the threaded section of the screw to thread through the annular washer, so that the annular washer is moved to and fitted around the shank of the screw to locate below the through opening on the sleeve and above an upper end of the threaded section of the screw.

Since the threaded section of the screw is threaded through instead of being forcefully pressed through the annular washer during assembling the screw and the sleeve to each other, the annular washer may keep a small inner diameter for tightly fitting around the shank of the screw to ensure strong and reliable coupling of the screw with the sleeve. Moreover, with the small inner diameter, the annular washer does not need to have an increased size. Therefore, the whole captive screw may have a reduced overall volume. Further, only an annular base is required to assist in the assembling of the sleeve to the screw. As a result, the captive screw may be manufactured at reduced cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a captive screw;

FIG. 2 is an assembled sectional view of the captive screw of FIG. 1;

FIGS. 3 to 5 show a conventional method of assembling a captive screw;

FIG. 6 is an enlarged view of the circled area in FIG. 5;

FIGS. 7 to 11 show the assembling of a captive screw in a method according to a preferred embodiment of the present invention; and

FIG. 12 is an enlarged view of the circled area in FIG. 11.

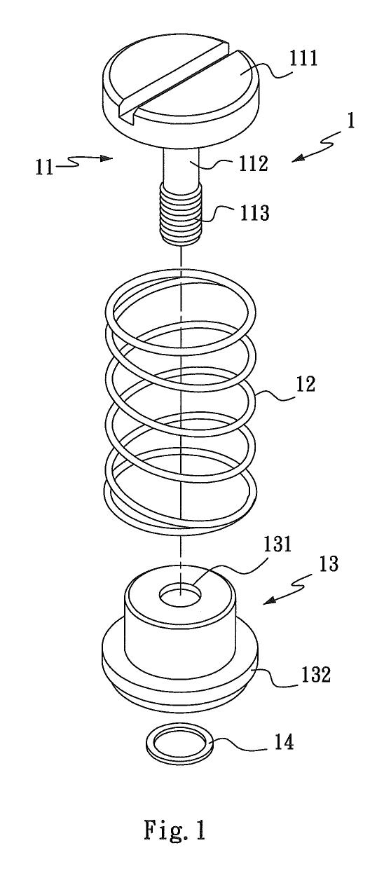

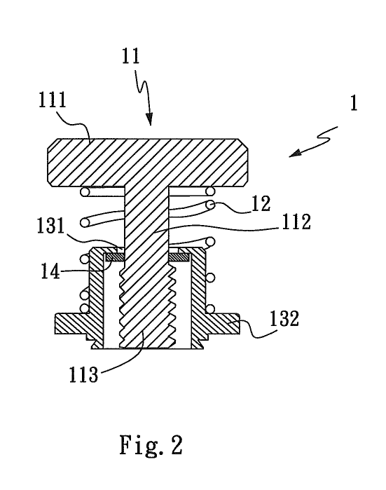

### DETAILED DESCRIPTION OF THE PREFERRED EMBODIMENTS

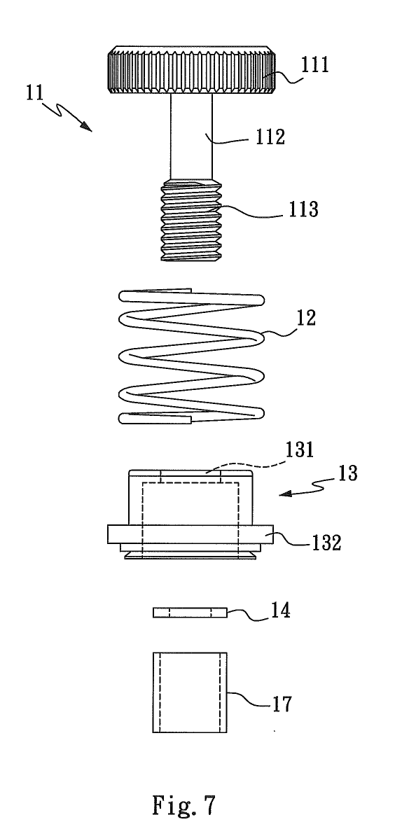

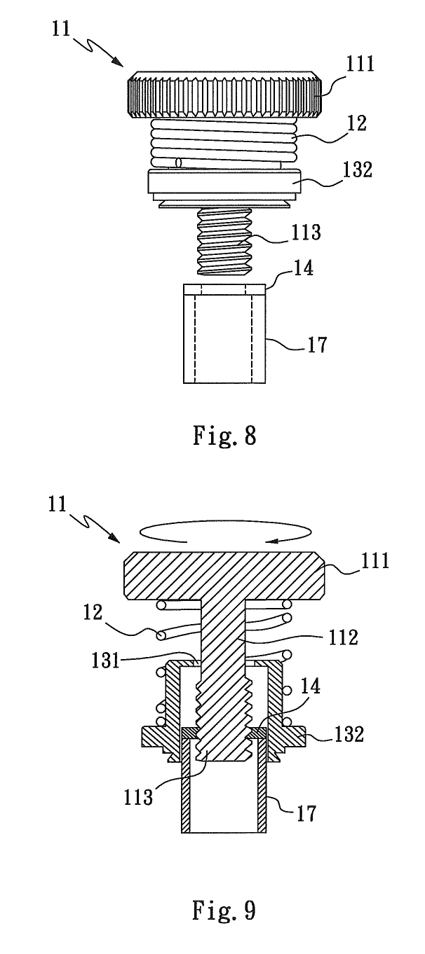

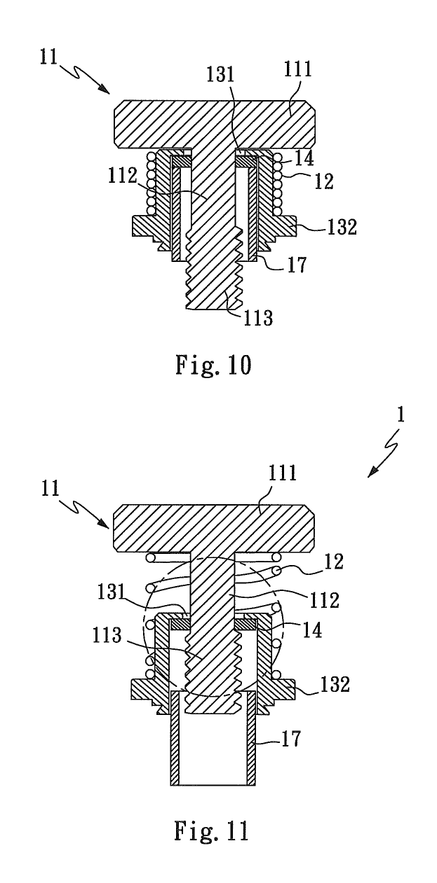

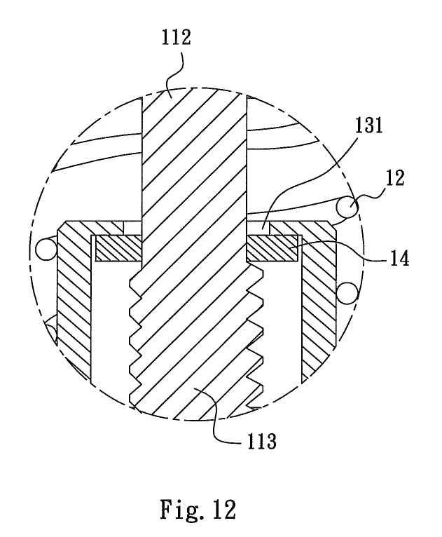

Please refer to FIGS. 7 through 11 that show a method of assembling captive screw according to a preferred embodiment of the present invention, and to FIG. 12 that is an enlarged view of the circled area in FIG. 11.

As shown, the method of assembling captive screw according to the present invention includes the following steps:
(1) provide an annular base 17 and position an annular washer 14 on a top of the annular base 17;
(2) provide a screw 11, a coil spring 12, and a sleeve 13; wherein the screw 11 includes from top to bottom a head 111, a shank 112, and a threaded section 113, and the sleeve 13 is provided on a top with a diametrically reduced through opening 131;
(3) downward passed the threaded section 113 of the screw 11 through the coil spring 12 and the through opening 131 on the sleeve 13, so that two ends of the coil spring 12 are respectively pressed against the head 111 of the screw 1 and a predetermined position on the sleeve 13; and
(4) cause helical screw threads on the threaded section 113 of the screw 11 to thread through the annular washer 14, so that the annular washer 14 is moved to and fitted around the shank 112 of the screw 11 to locate below the through opening 131 on the sleeve 13 and above an upper end of the threaded section 113 of the screw 11.

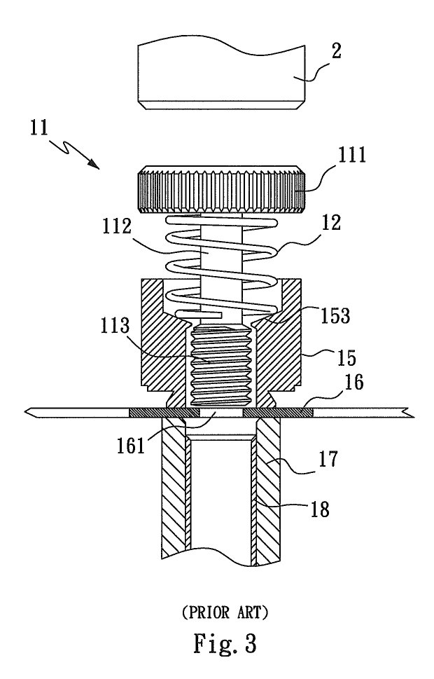

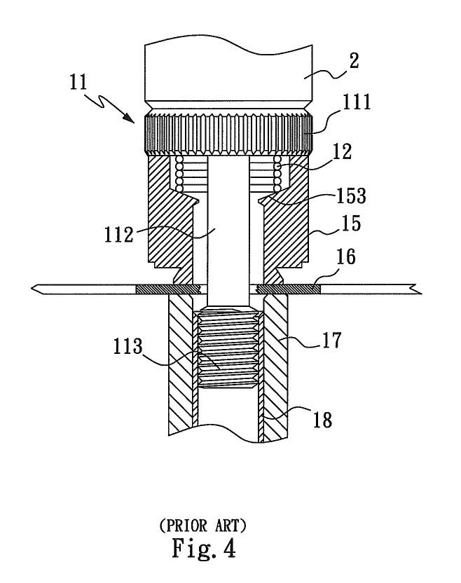

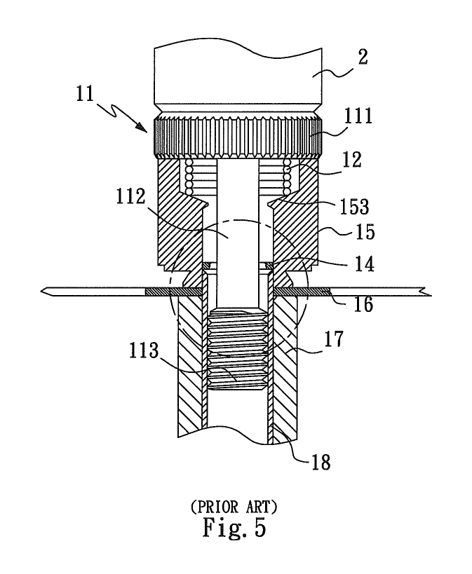

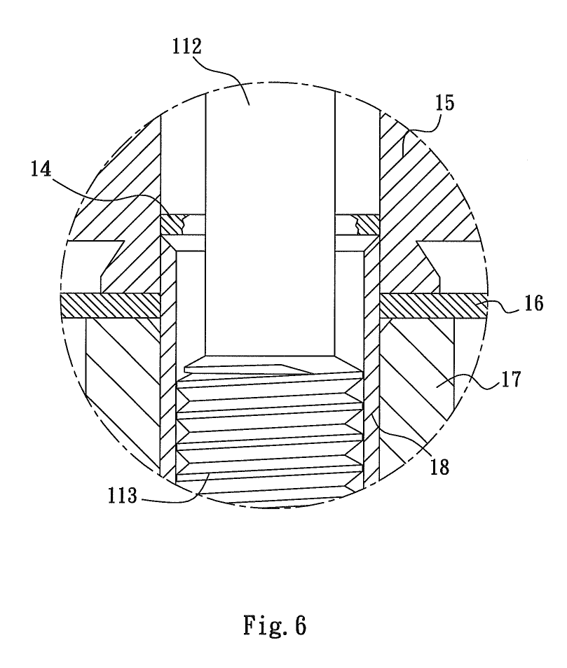

As can be seen from FIG. 7, the sleeve 13 is provided around a lower outer surface with an annular stop flange 132, and the two ends of the coil spring 12 are respectively pressed against the head 111 of the screw 11 and the annular stop flange 132 on the sleeve 13. Alternatively, when the captive screw includes a sleeve 15 internally provided with an annular shoulder portion 153 as that shown in FIG. 3, the two ends of the coil spring 12 are respectively pressed against the head 111 of the screw 11 and the shoulder portion 153 in the sleeve 15.

The method of assembling captive screw according to the present invention is characterized in that the threaded section 113 of the screw 11 is passed through the annular washer 14 by threading the helical screw threads on the threaded section 113 through the annular washer 14. Since the annular washer 14 is provided with a certain degree of elasticity, the threading of the helical screw threads on the threaded section 113 through the annular washer 14 would not cause any significant wearing of the inner circumferential edge of the annular washer 14. Therefore, the annular washer 14 may still have the original small inner diameter and thereby tightly fit around the shank 112 of the screw 11 with the small inner circumferential edge thereof providing sufficient strength for bearing against the upper end of the threaded section 113, ensuring the sleeve 13 is reliably assembled to the screw 11. Further, since the inner circumferential edge of the annular washer 14 is not significantly worn away to maintain the original small inner diameter of the annular washer 14, the annular washer 14 may be made to an even reduced size, which in turn allows a reduced overall volume of the captive screw. It is also noted only a simple annular base is needed in the process of assembling the captive screw using the method of the present invention, enabling the captive screw to be produced at reduced cost. Therefore, the method of the present invention for assembling a captive screw is industrially practical and valuable for use to meet the existing market demands.

What is claimed is:

1. A method of assembling captive screw, comprising the following steps:
(1) providing an annular base and positioning an annular washer on a top of the annular base;
(2) providing a screw, a coil spring, and a sleeve; wherein the screw includes from top to bottom a head, a shank, and a threaded section, and the sleeve is provided on a top with a diametrically reduced through opening;
(3) downward passing the threaded section of the screw through the coil spring and the through opening on the sleeve, so that two ends of the coil spring are respectively pressed against the head of the screw and a predetermined position on the sleeve; and
(4) causing helical screw threads on the threaded section of the screw to thread through the annular washer, so that the annular washer is moved to and fitted around the shank of the screw to locate below the through opening on the sleeve and above an upper end of the threaded section of the screw.

2. The method of assembling captive screw as claimed in claim 1, wherein the sleeve is provided around a lower outer surface with an annular stop flange, and the two ends of the coil spring are respectively pressed against the head of the screw and the stop flange on the sleeve.

3. The method of assembling captive screw as claimed in claim 1, wherein the sleeve is provided around an inner surface with an annular shoulder portion, and the two ends of the coil spring are respectively pressed against the head of the screw and the shoulder portion in the sleeve.
